(19) United States
(12) Patent Application Publication
(10) Pub. No.: US 2018/0083474 A1
(43) Pub. Date: Mar. 22, 2018

(54) WIRELESS POWERING FOR ELECTRONIC AUXILIARY DEVICES

(71) Applicant: Microsoft Technology Licensing, LLC, Redmond, WA (US)

(72) Inventor: Markku Rajamäki, Littoinen (FI)

(21) Appl. No.: 15/269,939

(22) Filed: Sep. 19, 2016

(51) Int. Cl. H02J 7/02; H02J 50/10; G06F 1/16

(52) U.S. Cl. CPC H02J 7/025; G06F 1/1656; G06F 1/163; H02J 50/10

(57) ABSTRACT

In one example, a system comprises an electronic auxiliary device with a receiving inductive charging coil connected to it. The system further comprises a handheld electronic apparatus comprising a power source and a transmitting inductive charging coil. The handheld electronic apparatus further comprises a controller configured to cause a wireless electrical energy transfer from the transmitting inductive charging coil to the receiving inductive charging coil, in response to determining that the transmitting inductive charging coil of the handheld electronic apparatus is in proximity to the receiving inductive charging coil connected to the electronic auxiliary device.

### BACKGROUND

Wearable electronic devices, such as sensors measuring heart rate or body temperature, embedded in a shirt or a jacket can be powered by e.g. a battery, a solar cell, or the like. In some instances, having a battery or the like for wearable electronics may require extra concerns, such as how to charge the battery (extra charger needed), when to charge the battery (monitoring needed) and having to remember to remove the battery when the shirt/jacket is washed. Batteries may be a safety hazard if not taken care of properly, and thus it may be challenging (for example for children) to have batteries embedded in wearables.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one example, a system comprises an electronic auxiliary device with a receiving inductive charging coil connected to it. The system further comprises a handheld electronic apparatus comprising a power source and a transmitting inductive charging coil. The handheld electronic apparatus further comprises a controller configured to cause a wireless electrical energy transfer from the transmitting inductive charging coil to the receiving inductive charging coil, in response to determining that the transmitting inductive charging coil of the handheld electronic apparatus is in proximity to the receiving inductive charging coil connected to the electronic auxiliary device.

In another example, a method and a handheld electronic apparatus have been discussed along with the features of the electronic auxiliary device.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is an example block diagram of a system with an electronic auxiliary device and a handheld electronic apparatus in accordance with an example embodiment;

FIG. 2 is an example flow diagram of a method in accordance with an example embodiment; and

FIG. 3 illustrates an example block diagram of an electronic mobile apparatus capable of implementing example embodiments described herein.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of operations for constructing and operating the example. However, the same or equivalent functions and sequences may be accomplished by different examples.

At least some of the disclosed examples may allow wireless powering for electronic auxiliary devices (such as wearable electronic auxiliary devices embedded in clothing, and the like) from a power source in a handheld electronic apparatus (such as a mobile phone). At least some of the disclosed examples may allow wireless powering for passive electronic auxiliary devices that do not have a power source of their own. At least some of the disclosed examples may allow such wireless powering with high efficiency due to use of magnets or the like to keep the electronic auxiliary device and the handheld electronic apparatus in proximity to each other, even when the user/wearer is moving about. At least some of the disclosed examples may allow such wireless powering without having to remember to remove a conventional dedicated battery usually associated with wearable electronic auxiliary devices when the associated clothing is washed. Accordingly, at least some of the disclosed examples may allow such wireless powering without safety hazards.

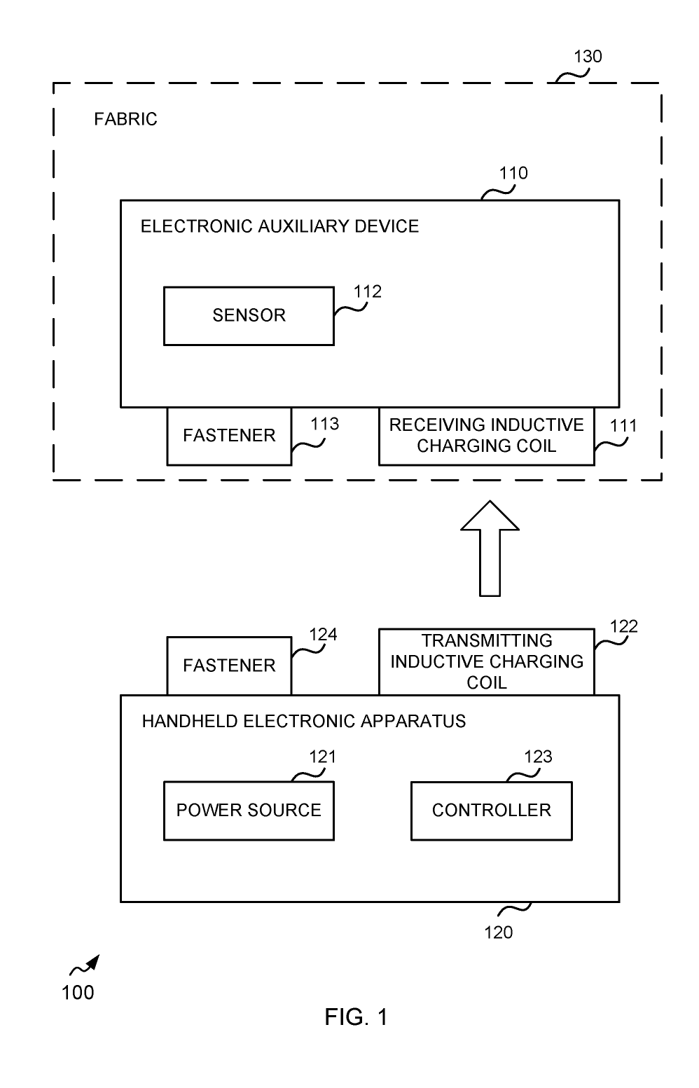

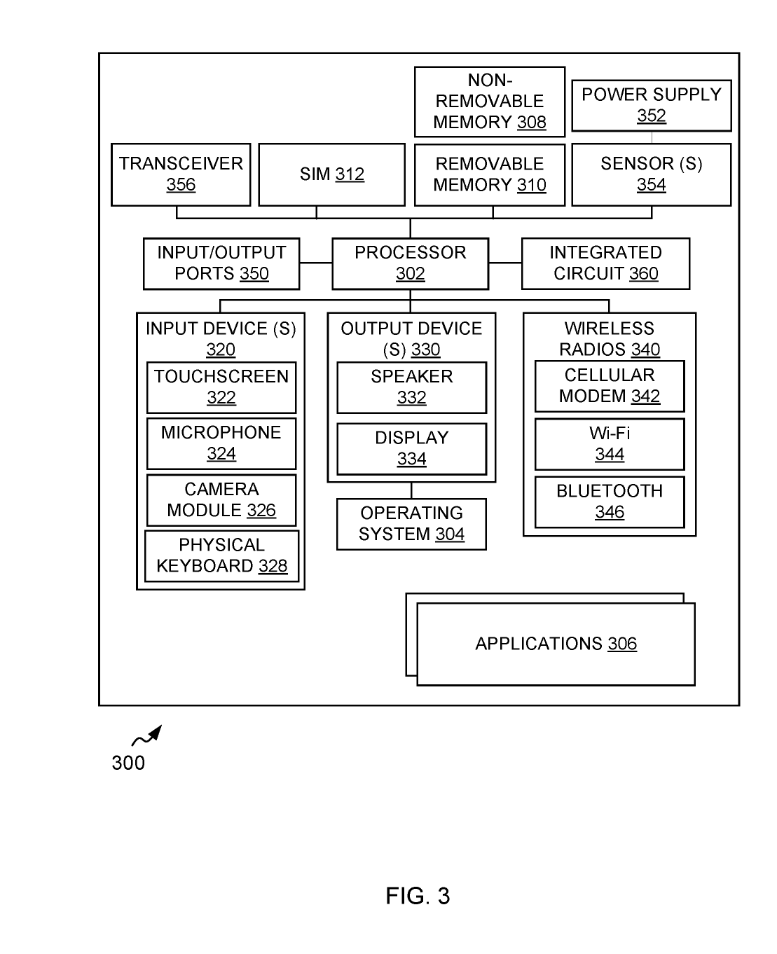

FIG. 1 is an example block diagram of a system 100 with an electronic auxiliary device 110 and a handheld (or mobile) electronic apparatus 120 in accordance with an example embodiment. The handheld electronic apparatus 120 may be employed, for example, in the electronic mobile apparatus 300 of FIG. 3. However, it should be noted that the handheld electronic apparatus 120 may also be employed on a variety of other devices and apparatuses, and therefore, embodiments should not be limited to application on devices and apparatuses such as the electronic mobile apparatus 300 of FIG. 3. Furthermore, it should be noted that at least some of the elements described below may not be mandatory and thus some may be omitted in certain embodiments. The handheld electronic apparatus 120 may include mobile communication devices (such as smart phones) and the like.

The system 100 comprises an electronic auxiliary device 110 with a receiving inductive charging coil 111 connected to it. The electronic auxiliary device 110 may comprise a sensor 112 (such as a heart rate sensor, a body temperature sensor, a velocity sensor, and/or an acceleration sensor), an illuminator (such as a light-emitting diode (LED)), an electric scent diffuser, an electric insect repellent, or any suitable electronic device with power consumption low enough to be powered by a handheld electronic apparatus 120 without draining the battery of the handheld electronic apparatus 120. The receiving inductive charging coil 111 maybe an inductive charging coil in accordance with the Qi standard developed by the Wireless Power Consortium for inductive electrical power transfer.

In an embodiment, the electronic auxiliary device 110 is passive in the sense that it does not have a power source (such as a battery or the like) of its own to power it. Herein, the term “own” power source refers to a power source integrated into the electronic auxiliary device 110, and/or to a power source connected to the electronic auxiliary device 110 in a permanent, fixed and/or non-wireless manner.

In an embodiment, the electronic auxiliary device 110 and its receiving inductive charging coil 111 may be wearable. For example, the wearable electronic auxiliary device 110 and/or its receiving inductive charging coil 111 may be embedded in a piece of fabric 130, such as a shirt or a jacket. The piece of fabric 130 may comprise a holder (e.g. a shirt/jacket pocket) in proximity to the receiving inductive charging coil 111 that can receive and hold the handheld electronic apparatus 120.

In an embodiment, the electronic auxiliary device 110 and its receiving inductive charging coil 111 may be embedded in a piece of fabric used in a shelter, a dwelling or camping equipment, such as a tent or the like. For example, the electronic auxiliary device 110 may comprise an LED or another illuminator used to illuminate the interior of the fabric, an electric insect repellent used to repel insects from the tent, or an electric scent diffuser used to diffuse scents in the tent.

In another example, the holder may be a holder associated with a bicycle or an exercise bicycle, and the electronic auxiliary device 110 may comprise a sensor configured to monitor one or more activities related to the bicycle.

The system 100 further comprises a handheld electronic apparatus 120 that comprises a power source 121 and a transmitting inductive charging coil 122. The handheld electronic apparatus 120 may be a mobile communication device, such as a smart phone or the like. The power source 121 may comprise a battery (e.g. a lithium-ion (Li-ion) battery) or the like. The transmitting inductive charging coil 122 may be an inductive charging coil in accordance with the Qi standard.

The handheld electronic apparatus 120 further comprises a controller 123 that is configured to cause a wireless electrical energy transfer from the transmitting inductive charging coil 122 to the receiving inductive charging coil 111, in response to the transmitting inductive charging coil 122 of the handheld electronic apparatus 120 being placed in proximity to the receiving inductive charging coil 111 connected to the electronic auxiliary device 110. Herein, the proximity to the receiving inductive charging coil 111 may consist of distances less than or equal to one millimeter. The controller 123 may comprise hardware and/or software suitable for causing the wireless electrical energy transfer from the transmitting inductive charging coil 122 to the receiving inductive charging coil 111.

In an embodiment, the electronic auxiliary device 110 and/or the handheld electronic apparatus 120 may further comprise a fastener 113, 124 (such as a magnet) configured to attach the electronic auxiliary device 110 and the handheld electronic apparatus 120 to each other.

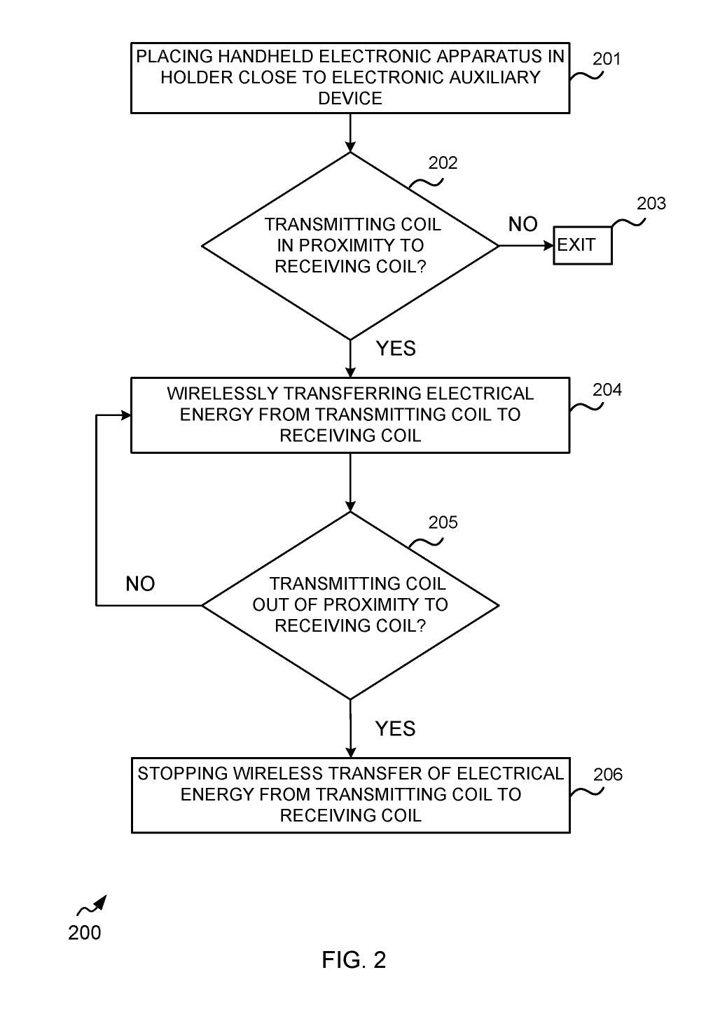

FIG. 2 is an example flow diagram of a method 200 in accordance with an example embodiment.

At operation 201, a handheld electronic apparatus with a transmitting inductive charging coil (e.g. a mobile phone with inductive charging capability) is placed in a holder (e.g. a shirt/jacket pocket) close to a receiving inductive charging coil connected to an electronic auxiliary device (e.g. a passive sensor embedded in the shirt/jacket), the handheld electronic apparatus comprising a battery.

At operation 202, it is determined whether the transmitting inductive charging coil of the handheld electronic apparatus is in proximity to (e.g. no farther than one millimeter) the receiving inductive charging coil connected to the electronic auxiliary device. If not, the method exits at operation 203. Otherwise, the method proceeds to operation 204.

At operation 204, a wireless electrical energy transfer from the transmitting inductive charging coil to the receiving inductive charging coil is caused by a controller of the handheld electronic apparatus.

At operation 205, it is determined whether the transmitting inductive charging coil of the handheld electronic apparatus is out of proximity (e.g. farther than one millimeter) to the receiving inductive charging coil connected to the electronic auxiliary device, e.g. due to the user removing the handheld electronic apparatus from the holder. If not, the method returns to operation 204. Otherwise, the method proceeds to operation 206.

At operation 206, the wireless electrical energy transfer from the transmitting inductive charging coil to the receiving inductive charging coil is stopped by the controller of the handheld electronic apparatus.

Operation 201 may be performed e.g. by the user. Operations 202-206 may be performed e.g. by the controller 123, the receiving inductive charging coil 111 and the transmitting inductive charging coil 122 of FIG. 1.

FIG. 3 is a schematic block diagram of an electronic mobile apparatus 300 capable of implementing embodiments of the techniques described herein. It should be understood that the electronic mobile apparatus 300 as illustrated and hereinafter described is merely illustrative of one type of apparatus or an electronic device and should not be taken to limit the scope of the embodiments. As such, it should be appreciated that at least some of the components described below in connection with the electronic mobile apparatus 300 may be optional and thus in an example embodiment may include more, less or different components than those described in connection with the example embodiment of FIG. 3. As such, among other examples, the electronic mobile apparatus 300 could be any of apparatuses incorporating a power source and a transmitting inductive charging coil. For example, the apparatus 300 may be implemented as a mobile phone, a smart phone, a tablet computer, or the like.

The illustrated electronic mobile apparatus 300 includes a controller or a processor 302 (i.e. a signal processor, microprocessor, ASIC, or other control and processing logic circuitry) for performing such tasks as signal coding, data processing, input/output processing, power control, and/or other functions. An operating system 304 controls the allocation and usage of the components of the electronic mobile apparatus 300 and support for one or more application programs 306. The application programs 306 can include common mobile applications, for instance, telephony applications, email applications, calendars, contact managers, web browsers, messaging applications, or any other application.

The illustrated electronic mobile apparatus 300 includes one or more memory components, for example, a non-removable memory 308 and/or removable memory 310. The non-removable memory 308 may include RAM, ROM, flash memory, a hard disk, or other well-known memory storage technologies. The removable memory 310 may include flash memory or smart cards. The one or more memory components may be used for storing data and/or code for running the operating system 304 and the applications 306. Examples of data may include web pages, text, images, sound files, image data, video data, or other data sets to be sent to and/or received from one or more network servers or other devices via one or more wired or wireless networks. The electronic mobile apparatus 300 may further include a subscriber identity module (SIM) 312. The SIM 312 typically stores information elements related to a mobile subscriber. A SIM is well known in Global System for Mobile Communications (GSM) communication systems, Code Division Multiple Access (CDMA) systems, or with third-generation (3G) wireless communication protocols such as Universal Mobile Telecommunications System (UMTS), CDMA1000, wideband CDMA (WCDMA) and time division-synchronous CDMA (TD-SCDMA), or with fourth-generation (3G) wireless communication protocols such as LTE (Long-Term Evolution). The SIM 312 may comprise a virtual SIM. Furthermore, multiple SIMs may be utilized.

The electronic mobile apparatus 300 can support one or more input devices 320 and one or more output devices 330. Examples of the input devices 320 may include, but are not limited to, a touchscreen 322 (i.e., capable of capturing finger tap inputs, finger gesture inputs, multi-finger tap inputs, multi-finger gesture inputs, or keystroke inputs from a virtual keyboard or keypad), a microphone 324 (i.e., capable of capturing voice input), a camera module 326 (i.e., capable of capturing still picture images and/or video images) and a physical keyboard 328. Examples of the output devices 330 may include, but are not limited to a speaker 332 and a display 334. Other possible output devices (not shown) can include piezoelectric or other haptic output devices. Some devices can serve more than one input/output function. For example, the touchscreen 322 and the display 334 can be combined into a single input/output device.

In an embodiment, the electronic mobile apparatus 300 may comprise a wireless radio(s) 340. The wireless radio(s) 340 can support two-way communications between the processor 302 and external devices, as is well understood in the art. The wireless radio(s) 340 are shown generically and can include, for example, a cellular modem 342 for communicating at long range with the mobile communication network, a Wi-Fi radio 344 for communicating at short range with a local wireless data network or router, and/or a BLUETOOTH radio 346. The cellular modem 342 is typically configured for communication with one or more cellular networks, such as a GSM/3G/3G network for data and voice communications within a single cellular network, between cellular networks, or between the mobile device and a public switched telephone network (PSTN).

The electronic mobile apparatus 300 can further include one or more input/output ports 350, a power supply 352, one or more sensors 354, for example an accelerometer, a gyroscope, a compass, or an infrared proximity sensor for detecting the orientation or motion of the electronic device 300, and a transceiver 356 (for wirelessly transmitting analog or digital signals), and an integrated circuit 360. The illustrated components are not required or all-inclusive, as any of the components shown can be deleted and other components can be added. The power supply 352 may include the power source 121 of FIG. 1. The integrated circuit 360 may include the controller 123 of FIG. 1.

Computer executable instructions may be provided using any computer-readable media that is accessible by computing based devices. Computer-readable media may include, for example, computer storage media such as memory and communications media. Computer storage media, such as memory includes volatile and non-volatile, removable and non-removable media implemented in any method or technology for storage of information such as computer readable instructions, data structures, program modules or the like. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media is shown within the computing based devices it will be appreciated that the storage may be distributed or located remotely and accessed via a network or other communication link, for example by using a communication interface.

An embodiment of a system comprises an electronic auxiliary device with a receiving inductive charging coil connected to said electronic auxiliary device; and a handheld electronic apparatus comprising a power source and a transmitting inductive charging coil, wherein the handheld electronic apparatus further comprises a controller configured to cause a wireless electrical energy transfer from the transmitting inductive charging coil to the receiving inductive charging coil, in response to determining that the transmitting inductive charging coil of the handheld electronic apparatus is in proximity to the receiving inductive charging coil connected to the electronic auxiliary device.

In an embodiment, alternatively or in addition to the above described embodiments, the electronic auxiliary device does not include a battery.

In an embodiment, alternatively or in addition to the above described embodiments, the electronic auxiliary device and the receiving inductive charging coil are wearable.

In an embodiment, alternatively or in addition to the above described embodiments, at least one of the wearable electronic auxiliary device and the receiving inductive charging coil is embedded in a piece of fabric.

In an embodiment, alternatively or in addition to the above described embodiments, the piece of fabric comprises a holder in proximity to the receiving inductive charging coil and configured to receive the handheld electronic apparatus.

In an embodiment, alternatively or in addition to the above described embodiments, the electronic auxiliary device comprises at least one of a sensor, an illuminator, a scent diffuser, and an insect repellent.

In an embodiment, alternatively or in addition to the above described embodiments, at least one of the electronic auxiliary device and the handheld electronic apparatus further comprises a fastener configured to attach the electronic auxiliary device and the handheld electronic apparatus to each other.

In an embodiment, alternatively or in addition to the above described embodiments, the fastener comprises a magnet.

In an embodiment, alternatively or in addition to the above described embodiments, the proximity to the receiving inductive charging coil consists of distances less than or equal to one millimeter.

An embodiment of a method comprises determining that a transmitting inductive charging coil of a handheld electronic apparatus is in proximity to a receiving inductive charging coil connected to an electronic auxiliary device, the handheld electronic apparatus comprising a battery; and causing, by a controller of the handheld electronic apparatus, a wireless electrical energy transfer from the transmitting inductive charging coil to the receiving inductive charging coil.

In an embodiment, alternatively or in addition to the above described embodiments, the method further comprises stopping, by the controller of the handheld electronic apparatus, the wireless electrical energy transfer from the transmitting inductive charging coil to the receiving inductive charging coil in response to the transmitting inductive charging coil of the handheld electronic apparatus being out of proximity to the receiving inductive charging coil connected to the electronic auxiliary device.

In an embodiment, alternatively or in addition to the above described embodiments, the electronic auxiliary device does not include a battery.

In an embodiment, alternatively or in addition to the above described embodiments, the electronic auxiliary device and the receiving inductive charging coil are wearable.

In an embodiment, alternatively or in addition to the above described embodiments, at least one of the wearable electronic auxiliary device and the receiving inductive charging coil is embedded in a piece of fabric.

In an embodiment, alternatively or in addition to the above described embodiments, the piece of fabric comprises a holder in proximity to the receiving inductive charging coil and configured to receive the handheld electronic apparatus.

In an embodiment, alternatively or in addition to the above described embodiments, the electronic auxiliary device comprises at least one of a sensor, an illuminator, a scent diffuser, and an insect repellent.

In an embodiment, alternatively or in addition to the above described embodiments, at least one of the electronic auxiliary device and the handheld electronic apparatus further comprises a fastener configured to attach the electronic auxiliary device and the handheld electronic apparatus to each other.

In an embodiment, alternatively or in addition to the above described embodiments, the fastener comprises a magnet.

In an embodiment, alternatively or in addition to the above described embodiments, the proximity to the receiving inductive charging coil consists of distances less than or equal to one millimeter.

An embodiment of a handheld electronic apparatus comprises a power source; a transmitting inductive charging coil; and a controller configured to cause a wireless electrical energy transfer from the transmitting inductive charging coil to a receiving inductive charging coil connected to an electronic auxiliary device, in response to determining that the transmitting inductive charging coil of the handheld electronic apparatus is in proximity to the receiving inductive charging coil connected to the electronic auxiliary device.

The embodiments illustrated and described herein as well as embodiments not specifically described herein but within the scope of aspects of the disclosure constitute exemplary means for wireless powering of electronic auxiliary devices from a power source in a handheld electronic apparatus. For example, the elements illustrated in FIG. 1 constitute exemplary means for determining a transmitting inductive charging coil of a handheld electronic apparatus being placed in proximity to a receiving inductive charging coil connected to an electronic auxiliary device; exemplary means for causing a wireless electrical energy transfer from the transmitting inductive charging coil to the receiving inductive charging coil; and exemplary means for stopping the wireless electrical energy transfer from the transmitting inductive charging coil to the receiving inductive charging coil.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include mobile telephones (including smart phones), tablet computers and many other devices.

The processes described herein may be performed by software in machine readable form on a tangible storage medium e.g. in the form of a computer program comprising computer program code means adapted to perform all the steps of any of the processes described herein when the program is run on a computer and where the computer program may be embodied on a computer readable medium. Examples of tangible storage media include disks, thumb drives, memory etc. and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims, and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

Aspects of any of the examples described above may be combined with aspects of any of the other examples described to form further examples without losing the effect sought.

The term ‘comprising’ is used herein to mean including the blocks or elements identified, but that such blocks or elements do not comprise an exclusive list, and a system, a device or an apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification. In particular, the individual features, elements, or parts described in the context of one example, may be connected in any combination to any other example also.

1. A system, comprising:
an electronic auxiliary device with a receiving inductive charging coil connected to said electronic auxiliary device; and
a handheld electronic apparatus comprising a power source and a transmitting inductive charging coil,
wherein the handheld electronic apparatus further comprises a controller configured to cause a wireless electrical energy transfer from the transmitting inductive charging coil to the receiving inductive charging coil, in response to determining that the transmitting inductive charging coil of the handheld electronic apparatus is in proximity to the receiving inductive charging coil connected to the electronic auxiliary device.

2. The system as claimed in claim 1, wherein the electronic auxiliary device does not include a battery.

3. The system as claimed in claim 1, wherein the electronic auxiliary device and the receiving inductive charging coil are wearable.

4. The system as claimed in claim 3, wherein at least one of the wearable electronic auxiliary device and the receiving inductive charging coil is embedded in a piece of fabric.

5. The system as claimed in claim 4, wherein the piece of fabric comprises a holder in proximity to the receiving inductive charging coil and configured to receive the handheld electronic apparatus.

6. The system as claimed in claim 1, wherein the electronic auxiliary device comprises at least one of a sensor, an illuminator, a scent diffuser, and an insect repellent.

7. The system as claimed in claim 1, wherein at least one of the electronic auxiliary device and the handheld electronic apparatus further comprises a fastener configured to attach the electronic auxiliary device and the handheld electronic apparatus to each other.

8. The system as claimed in claim 7, wherein the fastener comprises a magnet.

9. The system as claimed in claim 1, wherein the proximity to the receiving inductive charging coil consists of distances less than or equal to one millimeter.

10. A method, comprising:
determining that a transmitting inductive charging coil of a handheld electronic apparatus is in proximity to a receiving inductive charging coil connected to an electronic auxiliary device, the handheld electronic apparatus comprising a battery; and
causing, by a controller of the handheld electronic apparatus, a wireless electrical energy transfer from the transmitting inductive charging coil to the receiving inductive charging coil.

11. The method as claimed in claim 10, further comprising stopping, by the controller of the handheld electronic apparatus, the wireless electrical energy transfer from the transmitting inductive charging coil to the receiving inductive charging coil in response to the transmitting inductive charging coil of the handheld electronic apparatus being out of proximity to the receiving inductive charging coil connected to the electronic auxiliary device.

12. The method as claimed in claim 10, wherein the electronic auxiliary device does not include a battery.

13. The method as claimed in claim 10, wherein the electronic auxiliary device and the receiving inductive charging coil are wearable.

14. The method as claimed in claim 13, wherein at least one of the wearable electronic auxiliary device and the receiving inductive charging coil is embedded in a piece of fabric.

15. The method as claimed in claim 14, wherein the piece of fabric comprises a holder in proximity to the receiving inductive charging coil and configured to receive the handheld electronic apparatus.

16. The method as claimed in claim 10, wherein the electronic auxiliary device comprises at least one of a sensor, an illuminator, a scent diffuser, and an insect repellent.

17. The method as claimed in claim 10, wherein at least one of the electronic auxiliary device and the handheld electronic apparatus further comprises a fastener configured to attach the electronic auxiliary device and the handheld electronic apparatus to each other.

18. The method as claimed in claim 17, wherein the fastener comprises a magnet.

19. The method as claimed in claim 10, wherein the proximity to the receiving inductive charging coil consists of distances less than or equal to one millimeter.

20. A handheld electronic apparatus, comprising:
a power source;
a transmitting inductive charging coil; and
a controller configured to cause a wireless electrical energy transfer from the transmitting inductive charging coil to a receiving inductive charging coil connected to an electronic auxiliary device, in response to determining that the transmitting inductive charging coil of the handheld electronic apparatus is in proximity to the receiving inductive charging coil connected to the electronic auxiliary device.
